(19) United States
(12) Patent Application Publication
(10) Pub. No.: US 2009/0064756 A1
(43) Pub. Date: Mar. 12, 2009

(54) VACUUM GAUGE CALIBRATION APPARATUS CAPABLE OF CALIBRATING AND TESTING WITHOUT DISPLACEMENT AND OPERATING METHOD THEREOF

(75) Inventors: Seung Soo Hong, Daejeon (KR); Jin Tae Kim, Daejeon (KR); Ju Young Yun, Seoul (KR)

Correspondence Address: HISCOCK & BARCLAY, LLP, 2000 HSBC PLAZA, 100 Chestnut Street, ROCHESTER, NY, 14604-2404, US

(73) Assignee: Korea Research Institute of Standards and Science, Daejeon (KR)

(21) Appl. No.: 11/938,008

(22) Filed: Nov. 9, 2007

(30) Foreign Application Priority Data
Sep. 7, 2007 (KR) 10-2007-0090955

(51) Int. Cl. G01L 27/00

(52) U.S. Cl. 73/1.58

(57) ABSTRACT

The present invention provides a vacuum gauge calibration apparatus capable of calibrating and testing a vacuum gauge without displacement or separation of the vacuum gauge, the vacuum gauge being attached to a vacuum device under operation together with developing a movable vacuum gauge calibration device, and an operating method thereof. According to the present invention, there is provided an apparatus for calibrating and testing a vacuum gauge to be calibrated without displacement, the vacuum gauge being connected to a vacuum device, the apparatus comprising: a vacuum shut-off valve for opening and closing a piping for connecting the vacuum device to the to-be-calibrated vacuum gauge; and a movable vacuum gauge calibration device connected to the to-be-calibrated vacuum gauge, wherein the movable vacuum gauge calibration device includes: a reference vacuum gauge, a vacuum connection valve, a vacuum chamber, a gate valve, and an exhaust device which are connected to the to-be-calibrated vacuum gauge side in series; a gas supply source connected to the vacuum chamber for generating pressure in the vacuum chamber; a leak valve for controlling gas flow in the gas supply source and supplying the gas the vacuum chamber; and a vacuum gauge for the vacuum chamber for measuring vacuum pressure in the vacuum chamber.

### CROSS-REFERENCE TO RELATED APPLICATIONS

This application claims priority to Korean Patent Application No. 10-2007-0090955 filed Sep. 7, 2007.

### BACKGROUND OF THE INVENTION

1. Field of the Invention

The present invention relates to an apparatus for calibrating and testing a vacuum gauge and a method of operating the same, and more particularly, to a vacuum gauge calibration apparatus capable of calibrating and testing a vacuum gauge without displacement or separation of the vacuum gauge which is attached to a vacuum device under operation, and an operating method thereof.

2. Background of the Related Art

The present technology is one which enables the calibration of a vacuum gauge attached to the vacuum device under operation after comparing with a reference vacuum gauge attached to a movable calibration apparatus without separation from the vacuum device.

Up to now, it was necessary to stop the vacuum device under operation to calibrate or test almost all of the vacuum gauges. In other words, it was required to calibrate a vacuum gauge using a calibration device prepared separately after stopping the vacuum device, separating the vacuum gauge from the vacuum device and displacing it to the prepared place.

Thus, there was produced a large economical loss and time consumption, since the vacuum device was once stopped, the vacuum gauge detached from the vacuum device should be displaced, calibrated, and again attached to the vacuum device, and then it should be operated.

Here, the vacuum device may be a vacuum chamber, and the like, which is used in the manufacture process of a semiconductor, and a display.

### SUMMARY OF THE INVENTION

Accordingly, the present invention has been made in view of the above-mentioned problems occurring in the prior art, and an object of the present invention is to provide a vacuum gauge calibration apparatus capable of calibrating and testing a vacuum gauge without separating or displacing the vacuum gauge, which is attached to a vacuum device under operation by developing a movable vacuum gauge calibration apparatus, and an operating method thereof.

To accomplish the above object of the present invention, according to the present invention, there is provided an apparatus for calibrating and testing a to-be-calibrated vacuum gauge without displacement of the vacuum gauge, the vacuum gauge being connected to a vacuum device, the apparatus comprising: a vacuum shut-off valve for opening and closing a piping for connecting the vacuum device to the to-be-calibrated vacuum gauge; and a movable vacuum gauge calibration device connected to the to-be-calibrated vacuum gauge, wherein the movable vacuum gauge calibration device includes: a reference vacuum gauge, a vacuum connection valve, a vacuum chamber, a gate valve, and an exhaust device which are connected to the vacuum gauge side in series; a gas supply source connected to the vacuum chamber for generating pressure in the vacuum chamber; a leak valve for controlling gas flow in the gas supply source and supplying the gas to the vacuum chamber; and a vacuum gauge for the vacuum chamber for measuring the vacuum pressure in the vacuum chamber.

In addition, the movable vacuum gauge calibration device is constructed to be detachably connected to the to-be-calibrated vacuum gauge via a connection port.

Furthermore, the present invention provides a method of calibrating and testing a to-be-calibrated vacuum gauge, which is connected to a vacuum device under operation, the method comprising the steps of intercepting a piping for connecting the vacuum device and the to-be-calibrated vacuum gauge by using a vacuum shut-off valve; connecting a movable vacuum gauge calibration device to a connection port disposed at the to-be-calibrated vacuum gauge; forming a vacuum atmosphere in a vacuum chamber and all the connection pipings by operating an exhaust device after opening a vacuum connection valve and a gate valve of the movable vacuum gauge calibration device; determining if the vacuum gauge is at a high vacuum state or at a low vacuum state based on a measured range of the to-be-calibrated vacuum gauge; and acquiring a correction value by recording and comparing respective indication pressures of the to-be-calibrated vacuum gauge and a reference vacuum gauge while increasing the pressure in the vacuum chamber after closing the gate valve and opening a leak valve, when the measured range of the to-be-calibrated vacuum gauge is determined to be at a low vacuum state.

Also, the present invention further includes a step of confirming an ultimate pressure by measuring the pressure of the vacuum chamber by using a vacuum gauge for the vacuum chamber between the step of forming a vacuum atmosphere and the step of determining the state of the vacuum gauge.

Moreover, the present invention further includes a step of acquiring a correction value by recording and comparing respective indication pressures of the to-be-calibrated vacuum gauge and a reference vacuum gauge while increasing the pressure in the vacuum chamber after opening the gate valve and the leak valve, when the measured range of the to-be-calibrated vacuum gauge is determined to be at a high vacuum state.

In addition, according to the present invention, the gas from the gas supply source flowing into the vacuum chamber is adapted to pass through an orifice.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view showing a construction of a vacuum gauge calibration apparatus capable of calibrating and testing a vacuum gauge without displacement of the vacuum gauge according to the present invention;

FIG. 2 is a flow chart showing a method of operating the vacuum gauge calibration apparatus capable of calibrating and testing a vacuum gauge without displacement of the vacuum gauge according to the present invention.

### DETAILED DESCRIPTION OF THE PREFERRED EMBODIMENT

Hereinafter, the vacuum gauge calibration apparatus capable of calibrating and testing a vacuum gauge without displacement of the vacuum gauge, and the method of operating the same of the present invention will be described in detail with reference to the appended drawings.

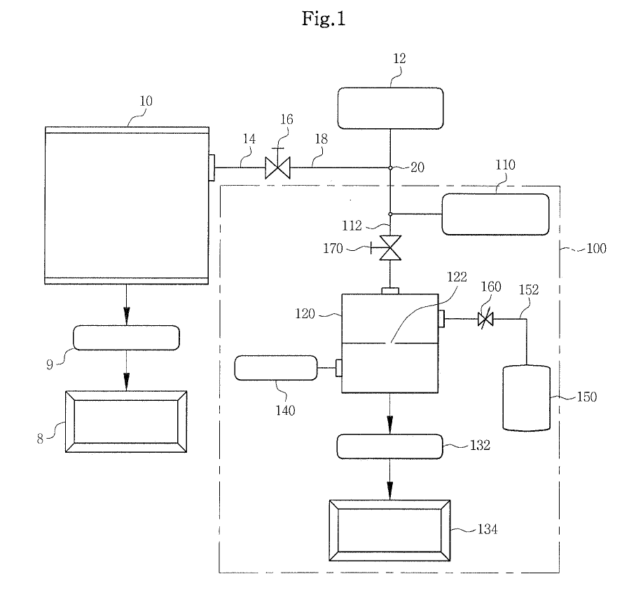

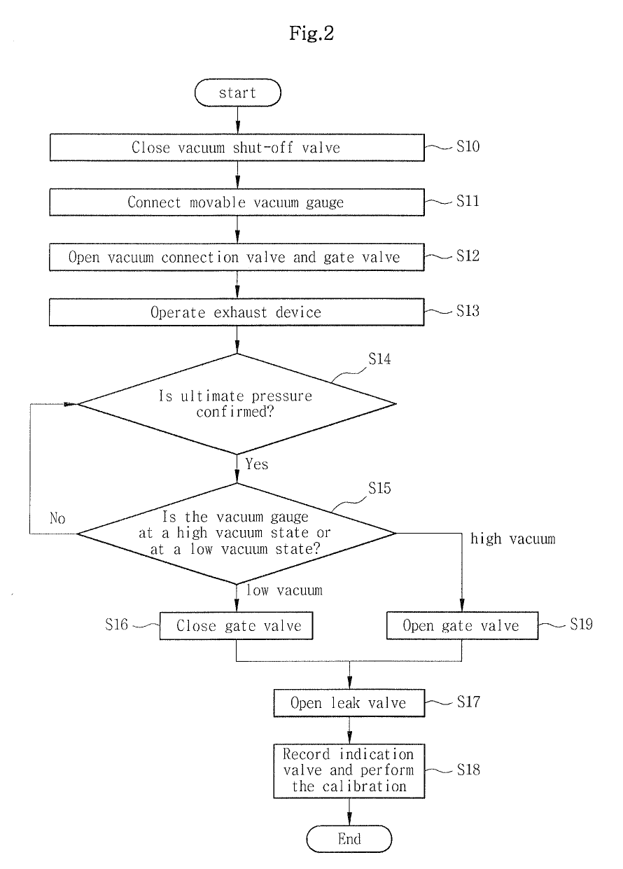

FIG. 1 is a schematic view showing a construction of a vacuum gauge calibration apparatus capable of calibrating and testing a vacuum gauge without displacement of the vacuum gauge according to the present invention, and FIG. 2 is a flow chart showing a method of operating the vacuum gauge calibration apparatus capable of calibrating and testing a vacuum gauge without displacement of the vacuum gauge according to the present invention.

The present invention is to calibrate and/or test the to-be-calibrated vacuum gauge, which is connected to the vacuum device 10, as shown in FIG. 1. A vacuum shut-off valve 16 is installed at a piping 14 connecting the vacuum device 10 and the vacuum gauge 12 to be calibrated. Accordingly, when the vacuum shut-off valve 16 is closed, vacuum pressure will not be applied to the vacuum gauge 12 to be calibrated. In addition, a movable vacuum gauge calibration device 100 is connected to a piping 18 which connects the vacuum shut-off valve 16 to the vacuum gauge 12 to be calibrated.

The movable vacuum gauge calibration device 100 is a device for obtaining a calibration value based on a difference between respective vacuum pressure indicated by the vacuum gauge 12 to be calibrated and the reference vacuum gauge 110 by the vacuum pressure produced at a vacuum chamber 120. In this instant, a gas supply source 150 is used to adjust the vacuum pressure in the vacuum chamber 120.

At first, the movable vacuum gauge calibration device 100 is constructed that the reference vacuum gauge 110 and the vacuum chamber 120 are installed at the piping 18 in parallel. In addition, a vacuum connection valve 170 is installed at a piping 112 connecting the reference vacuum gauge 110 to the vacuum chamber 120.

The vacuum chamber 120 is provided with an exhaust device 134 for producing a vacuum in the vacuum chamber 120 and a gate valve 132 for maintaining it. The gate valve 132 is installed between the exhaust device 134 and the vacuum chamber 120. Here, according to the present embodiment, the exhaust device 134 is constructed by combining a rotary pump and a turbo pump. The vacuum chamber 120 is provided with a vacuum gauge 140 for measuring a vacuum degree in the vacuum chamber 120. In the present embodiment, the vacuum gauge 140 for the vacuum chamber is constructed of an ion gauge.

Furthermore, a gas supply source 150 is connected to the vacuum chamber 120 for producing a desired pressure in the vacuum chamber 120. In addition, a leak valve 160 is installed at a piping 152 connecting the gas supply source 150 to the vacuum chamber 120 for interrupting the gas flow in the gas supply source 150. In the present embodiment, the gas supply source 150 is constructed of a gas tank storing the gas at a desired pressure.

Moreover, it is preferable to provide a connection port 20 at the piping 18 for detachably connecting the movable vacuum gauge calibration device 100 to it. Also, the vacuum chamber 120 is preferable to be provided with an orifice 122 for stabilizing the gas flow and reducing the pressure gradient at the same time.

Hereinafter, the action of the present embodiment will be described in connection with FIG. 2 showing a flow chart of carrying out the method of the present invention.

First, the vacuum shut-off valve 16 is closed (S10), and the piping connecting the vacuum gauge 10 under operation to the vacuum gauge 12 to be calibrated is intercepted. In this instance, the vacuum device 10 has been formed with a vacuum by the operation of the exhaust device 8 after the opening of the gate valve 9. Then, the movable vacuum gauge calibration device 100 is connected to the connection port 20 (S11).

Next, the vacuum connection valve 170 and the gate valve 132 are opened (S12), and the exhaust device 134 is operated (S13). Then, the vacuum chamber 120 and all the connection pipings connected to the vacuum chamber 120 are formed with vacuum. Next, the pressure in the vacuum chamber 120 is measured by the vacuum gauge 140 to confirm if an ultimate pressure is low enough or not (S14).

Then, it is determined if the to-be-calibrated vacuum gauge 12 is at a high vacuum state or at a low vacuum state, when the vacuum chamber 120 reaches an ultimate pressure (S15). Here, if the vacuum gauge 12 to be calibrated is determined to be at a low vacuum pressure (measured range: about 0.1 Pa to 100 kPa), the gate valve 132 is closed and the leak valve 160 is opened (S17). Then, the gas filled in the gas supply source 150 is supplied to the vacuum chamber 120, thereby increasing the pressure, recording and comparing the indicated pressures of the vacuum gauge 12 to be calibrated and the reference vacuum gauge 110, and performing the calibration (S18). In this instance, the calibration of the vacuum gauge 12 to be calibrated is performed by setting a difference between the pressures indicated by the vacuum gauge 12 to be calibrated and the reference vacuum gauge 110 as a correction value.

Meanwhile, if the vacuum gauge 12 to be calibrated is at a high vacuum (measured range: about 10⁻¹ Pa ˜10⁻⁶ Pa), the gate valve 132 is opened (S19), and the leak valve 160 is also opened (S17), thereby leaking the gas in the gas supply source 150, resulting in the production of a desired pressure in the vacuum chamber 120. In this instance, a correction value is obtained by the recording and comparison of respective indication pressure of the vacuum gauge 12 to be calibrated with the reference vacuum gauge 110 (S18). As a result, the gas flow of the vacuum chamber 120 is stabilized because it passes through the orifice 122, so that the pressure gradient of the piping to which the vacuum gauges 12, 110 are connected is minimized.

Here, the reference vacuum gauge 110 is required to be previously calibrated by a standard device. When a desired pressure is produced at the vacuum chamber 120 by the opening of the leak valve 160, the indication pressures of the vacuum gauge 12 to be calibrated and the reference vacuum gauge 110 are read and recorded. It is preferable to compare and calibrate pressure of the vacuum gauge 12 to be calibrated with that of the reference vacuum gauge 110, together with increasing the pressure of the vacuum chamber 120 to the desired maximum pressure.

In addition, if the calibrations are repeatedly required at the low vacuum and at the high vacuum respectively, the work of comparing and calibrating the difference of the indication pressures of the vacuum gauge 12 to be calibrated with the reference vacuum gauge 110 is repeatedly performed by operating the exhaust device 134 and the leak valve 160 under a vacuum atmospheric state of the respective connection piping.

As described above, according to the vacuum gauge calibration apparatus capable of calibrating and testing a vacuum gauge without displacement of the vacuum gauge and the operating method thereof of the present invention, it is possible to calibrate the vacuum gauge, which is attached to a vacuum device and the like used in a manufacturing process of a semiconductor, a manufacturing process of a display, and the like, and used to measure the vacuum pressure of a process at the vacuum state, without detachment or displacement.

As a result, it is possible to largely increase an economic property and an efficiency of the vacuum device because the vacuum gauge can be calibrated and tested during the operation of the vacuum device.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An apparatus for calibrating and testing a vacuum gauge 12 to be calibrated without displacement, the vacuum gauge being connected to a vacuum device 10, the apparatus comprising:
a vacuum shut-off valve 16 for opening and closing a piping 14, 18 for connecting the vacuum device 10 to the to-be-calibrated vacuum gauge 12; and
a movable vacuum gauge calibration device 100 connected to the to-be-calibrated vacuum gauge 12,
wherein the movable vacuum gauge calibration device 100 includes:
a reference vacuum gauge 110, a vacuum connection valve 170, a vacuum chamber 120, a gate valve 132, and an exhaust device 134 which are connected to the to-be-calibrated vacuum gauge 12 side in series;
a gas supply source 150 connected to the vacuum chamber 120 for generating pressure in the vacuum chamber 120;
a leak valve 160 for controlling gas flow in the gas supply source 150 and supplying the gas to the vacuum chamber 120; and
a vacuum gauge 140 for the vacuum chamber for measuring vacuum pressure in the vacuum chamber 120.

2. The apparatus for calibrating and testing a vacuum gauge according to claim 1, wherein the movable vacuum gauge calibration device 100 is constructed to be detachably connected to the to-be-calibrated vacuum gauge 12 via a connection port 20.

3. The apparatus for calibrating and testing a vacuum gauge according to claim 1, wherein the vacuum chamber 120 is further provided with an orifice 122 for stabilizing gas flow and reducing a pressure gradient

4. The apparatus for calibrating and testing a vacuum gauge according to claim 1, wherein the gas supply source 150 comprises a gas tank for storing gas under a desired pressure.

5. A method of calibrating and testing a vacuum gauge 12, which is connected to a vacuum device 10 under operation and is to be calibrated, the method comprising the steps of:
intercepting a piping for connecting the vacuum device 10 to the to-be-calibrated vacuum gauge 12 by using a vacuum shut-off valve 16;
connecting a movable vacuum gauge calibration device 100 to a connection port 20 installed at the to-be-calibrated vacuum gauge 12;
forming a vacuum atmosphere in a vacuum chamber 120 and all the connection pipings by operating an exhaust device 134 after opening a vacuum connection valve 170 and a gate valve 132 of the movable vacuum gauge calibration device 100;
determining if the to-be-calibrated vacuum gauge 12 is at a high vacuum state or at a low vacuum state based on a measured range of the to-be-calibrated vacuum gauge 12; and
acquiring a correction value by recording and comparing respective indication pressure of the to-be-calibrated vacuum gauge 12 with a reference vacuum gauge 110 while increasing the pressure in the vacuum chamber 120 after closing the gate valve 132 and opening a leak valve 160, when the measured range of the to-be-calibrated vacuum gauge 12 is determined to be at a low vacuum state.

6. The method of calibrating and testing a vacuum gauge according to claim 5, further including a step of confirming an ultimate pressure by measuring the pressure of the vacuum chamber 120 by using a vacuum gauge 140 for the vacuum chamber, between the step of forming a vacuum atmosphere and the step of determining the state of the vacuum gauge 12.

7. The method of calibrating and testing a vacuum gauge according to claim 5, further including a step of acquiring a correction value by recording and comparing respective indication pressures of the to-be-calibrated vacuum gauge 12 and the reference vacuum gauge 110 while increasing the pressure in the vacuum chamber 120 after opening the gate valve 132 and the leak valve 160, when the measured range of the to-be-calibrated vacuum gauge 12 is determined to be at a high vacuum state.

8. The method of calibrating and testing a vacuum gauge according to claim 7, wherein the gas from the gas supply source 150 flowing into the vacuum chamber 120 is adapted to pass through an orifice 122.
